(19) United States
(12) Patent Application Publication
(10) Pub. No.: US 2009/0095794 A1
(43) Pub. Date: Apr. 16, 2009

(54) Welding system

(75) Inventor: Jong Cheol Kim, Gyeonggi-do (KR)

Correspondence Address: Edwards Angell Palmer & Dodge LLP, P.O. Box 55874, Boston, MA, 02205, US

(73) Assignee: Hyundai Motor Company, Seoul (KR)

(21) Appl. No.: 12/006,197

(22) Filed: Dec. 31, 2007

(30) Foreign Application Priority Data
Oct. 15, 2007 (KR) 10-2007-0103566

(51) Int. Cl. B23K 37/047; B23K 31/02

(52) U.S. Cl. 228/103; 228/47.1; 219/79

(57) ABSTRACT

The present invention relates to a welding system. The welding system comprises: a fixing jig for securely fixing any one of a plurality of to-be-welded objects; a movable jig for moving another of the plurality of to-be-welded objects a movable block for horizontally moving the movable jig; a block driving mechanism for driving the movable block; a position sensor for detecting the position of the movable jig; and a control device for receiving position data from the position sensor to control the block driving mechanism. According to a welding system of the present invention, it is possible sequentially identify the positions of the to-be-welded objects after the melting and shrinkage thereof using a position sensor and determine an optimal welding position of the to-be-welded objects during the welding to thereby realize an optimal finished product.

### CROSS-REFERENCE TO RELATED APPLICATION

This application claims the benefit under 35 U.S.C. §119(a) of Korean Patent Application No. 10-2007-0103566 filed on Oct. 15, 2007, the entire contents of which are incorporated herein by reference.

### BACKGROUND

(a) Technical Field

The present invention relates to a welding system. More particularly, the present invention relates to a welding system which can identify the positions of objects to be welded (hereinafter, referred to as “to-be-welded objects”) after the melting and shrinkage occurring during a welding process and numerically control and change a distance between the to-be-welded objects to thereby perform optimal quality control.

(b) Background Art

To-be-welded objects are welded irrespective of welding conditions of current, voltage, speed, etc., of a welder and the length of the to-be-welded objects.

In general, the working process of a welding system is

In general, the working process of a welding system is performed such that to-be-welded objects are securely fixed to jigs to perform a welding, and the shrinkage of the to-be-welded objects is accumulated along with the progress of the welding. Due to this shrinkage accumulation of the to-be-welded objects, their lengths are relatively reduced as compared to their original lengths and the adjustment of a distance between the to-be-welded objects after the welding process is impossible, thereby resulting in production of a defective welding structure.

FIGS. 1 and 2 are diagrammatic views showing a thermal deformation process of textures of to-be-welded objects during the welding of the to-be-welded objects.

FIG. 1 shows a change in textures of to-be-welded objects during the heat welding in which the to-be-welded objects 1a and 1b, each having a length L, are securely fixed to jigs 3 and then a distance between the to-be-welded objects 1a and 1b becomes 0.

In a state where a distance between the welded portions of the to-be-welded objects 1a and 1b becomes 0, when the welded portions are heated by a welder, the textures of the welded portions are activated and their volume is expanded. Since the to-be-welded objects are fixed at one ends to the jigs 3, there is no change in expansion length of the to-be-welded objects in the X direction and there is a thermal expansion of the to-be-welded objects in the Y direction so that the length of the to-be-welded objects after the welding process is reduced to a length (2L-ΔL).

FIG. 2 shows a change in textures of to-be-welded objects during the heat welding in which a distance between the to-be-welded objects 7a and 7b, each having a length M(M<L), becomes “a”. In a state where a distance between the welded portions of the to-be-welded objects 7a and 7b becomes “a”, when the welded portions are heated by a welder, the textures of the welded portions are activated and their volume is expanded. Since the distance between the to-be-welded objects 7a and 7b is “a” during the expansion, the to-be-welded objects are thermally expanded in both the X and Y directions so that the length of the to-be-welded objects after the welding process is increased to a length (2M+ΔM).

As can be seen from the thermal deformation of the textures of the to-be-welded objects during the welding, there occurs a change in length of the to-be-welded objects due to shrinkage and deformation of the to-be-welded objects after the welding process, so that a welding is conducted regardless of a change in length of an item of a finished product and a correction of the shrinkage and deformation of the to-be-welded objects after the welding process is impossible, thereby leading to a distortion and a length reduction of the finished product.

The information disclosed in this Background of the Invention section is only for enhancement of understanding of the background of the invention and should not be taken as an acknowledgment or any form of suggestion that this information forms the prior art that is already known to a person skilled in that art.

### SUMMARY OF THE INVENTION

The present invention has been made in an effort to solve the above problems occurring in the prior art, and it is an object of the present invention to provide a welding system which can sequentially identify the positions of to-be-welded objects after the melting and shrinkage occurring at the time of welding the to-be-welded objects and numerically control and change a distance between the to-be-welded structure to thereby perform the optimal quality control.

In order to accomplish the above object, in one aspect, the present invention provides a welding system comprising: a fixing jig for securely fixing any one of a plurality of to-be-welded objects; a movable jig for moving another of the plurality of to-be-welded objects; a movable block for horizontally moving the movable jig; a block driving mechanism for driving the movable block; a position sensor for detecting the position of the movable jig; and a control device for receiving the detected position data from the position sensor and controlling the block driving mechanism.

In another aspect, the present invention provides a method of controlling a welding system, the method comprising the steps of: sensing the positions of to-be-welded objects after the melting and shrinkage thereof which occur during a welding process; comparing the sensed position information data with reference data; calculating an optimal welding position of the to-be-welded objects based on the compared result; adjusting and fixing the position of a movable jig based on the calculated result; welding the to-be-welded objects after the position adjustment of the movable jig; and moving the movable jig to a next welding position.

Other aspects of the invention are discussed inn.

### BRIEF DESCRIPTION OF THE DRAWINGS

FIG. 1 is a view showing a thermal deformation process of textures of to-be-welded objects in case where there is no distance between the to-be-welded objects during the heat welding;

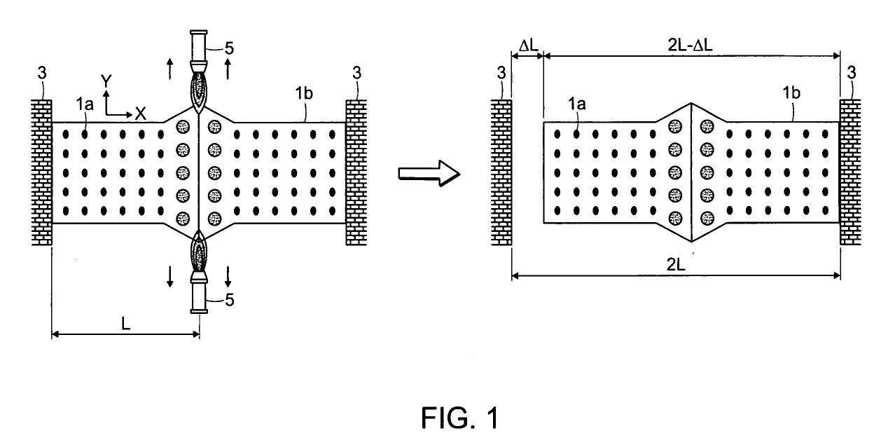

FIG. 2 is a view showing a thermal deformation process of textures of to-be-welded objects in case where there is any distance between the to-be-welded objects during the heat welding;

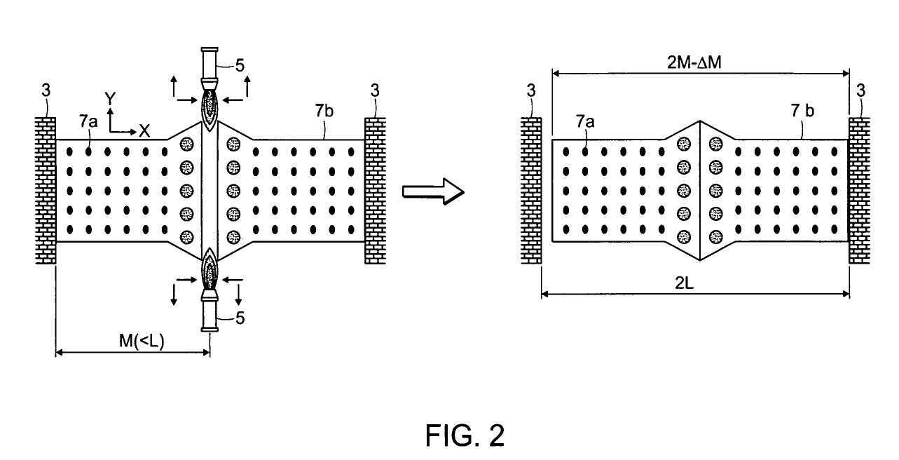

FIG. 3 is a perspective view showing an outer appearance of a position sensor including a light emitting section and a light receiving section of a welding system according to a preferred embodiment of the present invention;

FIG. 4 is a diagrammatic view showing the construction of a welding system according to a preferred embodiment of the present invention; and

FIG. 5 is a flow chart showing a control method of a welding system according to a preferred embodiment of the present invention.

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

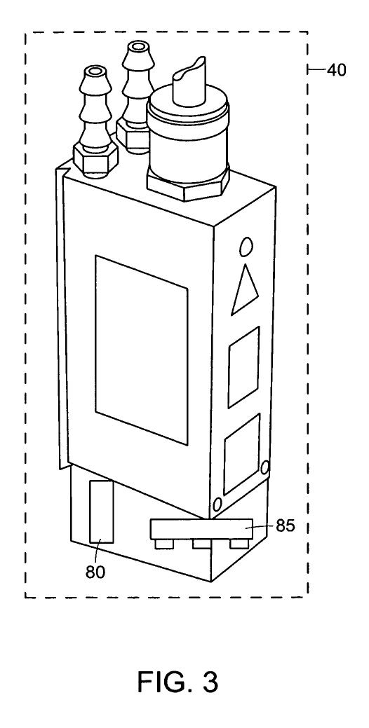

FIG. 3 is a perspective view showing an outer appearance of a position sensor of a welding system according to a preferred embodiment of the present invention;

The position sensor 40 includes a light emitting section 80 and a light receiving section 85. The position sensor is immobilized, and allows the light emitting section 80 to irradiate light and the light receiving section 85 to receive the light reflected after the irradiation to detect a change in position.

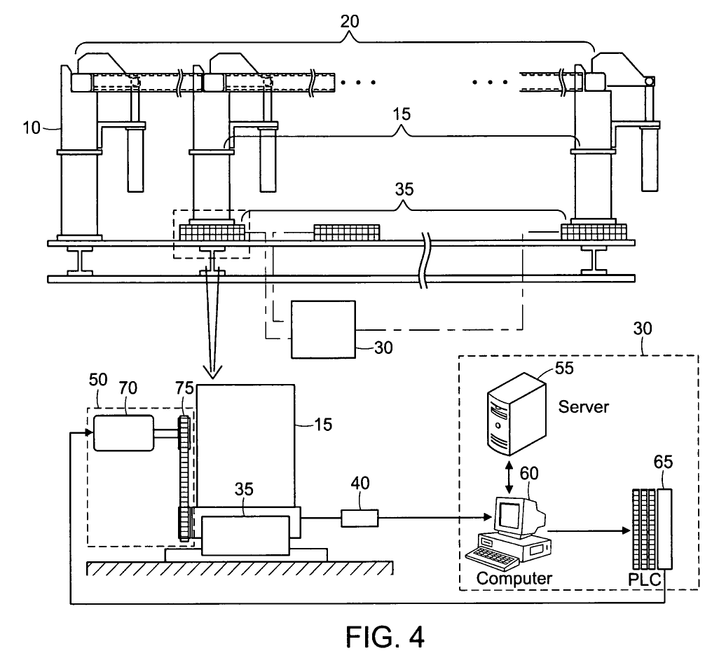

FIG. 4 is a diagrammatic view showing the construction of a welding system according to a preferred embodiment of the present invention.

As shown in FIG. 4, the welding system according to a preferred embodiment of the present invention includes a fixing jig 10, a movable jig 15, a plurality of to-be-welded objects 20, a control device 30, a movable block 35, a position sensor 40 and a block driving mechanism 50.

The fixing jig 10 serves to securely fix any one of to-be-welded objects 20. The movable jig 15 serves to hold a portion-to-be-welded of the to-be-welded objects 20 and can be moved by the movable blocks 35.

The positions of the to-be-welded objects 20 moved depending on a shrunk distance of the to-be-welded objects 20 after the welding are detected such that the light emitting section 80 of the position sensor 40 irradiates light onto the movable jig 15 and the light receiving section 85 receives the light reflected from the movable jigs so as to sense the positions of the to-be-welded objects which are shrunk and deformed for transmission to the controller 40.

The control device 30 includes a server 55 for comparing position data received from the position sensor 40 with reference data, a computer 60 for displaying a result compared by the server 55 and calculating an optimal position, and a programmable logic controller (PLC) 65 for receiving the calculated position data from the computer 60 and transmitting a signal for driving the block driving mechanism 50 to the block driving mechanism 50.

The block driving mechanism 50 receives the signal from the PLC 65 to operate the servo motor 70 capable of driving the movable block 35. The power transmission unit 75 of the block driving mechanism 50 transmits a driving force of the servo motor 70 to the movable block 35.

The movable block 35 receives the driving force of the servo motor 70 from the power transmission unit 75 of the block driving mechanism 50 and then moves to the to-be-welded object so that it repeatedly performs the above operation up to a distal end of the structure.

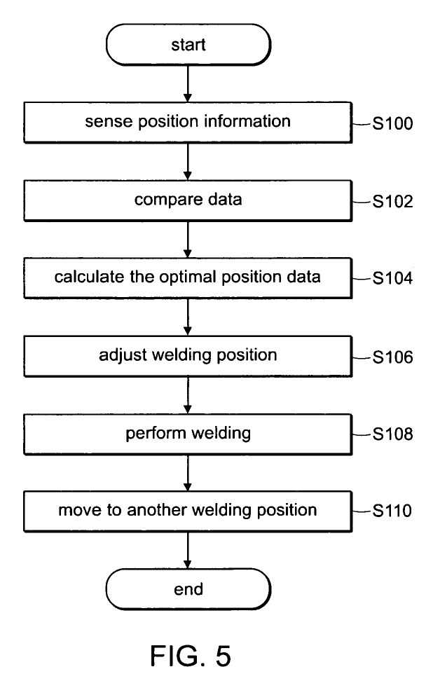

FIG. 5 is a flow chart showing a control method of a welding system according to a preferred embodiment of the present invention.

At step S100, the position sensor 40 senses the changed position of the to-be-welded objects after the melting and shrinkage thereof which occur during a welding process, and at step S102, the server 55 compares the sensed position information data with reference data stored the server 55 of the controller 30.

At step S104, the position data compared by the server 55 is calculated by the computer 60 to produce an optimal position data to perform the optimal welding operation, and at step S106, the control device 30 transmits the optimal position data to the block driving mechanism 50 to adjust a welding position.

Next, at step S108, the welding is performed after the adjustment of the welding position, and then the movable block 35 moves to a next welding position.

The above control process of the welding system is repeatedly performed up to a distal end of the to-be-welded objects and then is terminated.

As described above, according to a welding system of the present invention, it is possible sequentially identify the positions of the to-be-welded objects after the melting and shrinkage thereof using a position sensor and determine an optimal welding position of the to-be-welded objects during the welding to thereby realize an optimal finished product.

The invention has been described in detain with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A welding system comprising:
a fixing jig for securely fixing any one of a plurality of to-be-welded objects;
a movable jig for moving another of the plurality of to-be-welded objects
a movable block for horizontally moving the movable jig;
a block driving mechanism for driving the movable block;
a position sensor for detecting the position of the movable jig; and
a control device for receiving detected position data from the position sensor and controlling the block driving mechanism.

2. The welding system of claim 1, wherein the block driving mechanism comprises a servo motor for driving the movable block, and a power transmission unit for transmitting a driving force of the servo motor to the movable block.

3. The welding system of claim 1, wherein the position sensor comprises a light emitting section for irradiating light onto the movable jig and a light receiving section for receiving the light reflected from the movable jig.

4. The welding system of claim 1, wherein the control device comprises a server for comparing position data received from the position sensor with reference data, a computer for displaying result data compared by the server and calculating an optimal position data, and a programmable logic controller (PLC) for receiving the calculated position data from the computer and transmitting a command signal for driving the block driving mechanism to the block driving mechanism.

5. A method of controlling a welding system, the method comprising the steps of:
sensing the positions of to-be-welded objects after the melting and shrinkage thereof which occurs during a welding process;
comparing the sensed position information data with reference data;
calculating an optimal welding position of the to-be-welded objects based on the compared result;
adjusting and fixing the position of a movable jig based on the calculated result;
welding the to-be-welded objects after the position adjustment of the movable jig; and
moving the movable jig to a next welding position.
